(19) United States
(12) Patent Application Publication
(10) Pub. No.: US 2019/0193786 A1
(43) Pub. Date: Jun. 27, 2019

(54) CONTROL SYSTEM AND CONTROL METHOD FOR TURNING A MOTOR VEHICLE

(71) Applicant: Lucas Automotive GmbH, Koblenz (DE)

(72) Inventor: Rami Abusabbah, Koblenz (DE)

(21) Appl. No.: 16/200,690

(22) Filed: Nov. 27, 2018

(30) Foreign Application Priority Data
Dec. 21, 2017 (DE) 10 2017 011 920.1

(51) Int. Cl. B62D 15/02; B60Q 9/00

(52) U.S. Cl. CPC B62D 15/025; G06F 16/22; B60Q 9/00

(57) ABSTRACT

A control system for turning a motor vehicle is based on an environmental sensor system of the motor vehicle. The environmental sensor system is adapted to record at least one area in a direction of travel in front of the motor vehicle. A speedometer is provided and adapted to determine a speed of the motor vehicle. An interface is provided and adapted to communicate turning information to a driving entity of the motor vehicle. A controller is provided and adapted to identify a turning desire of the driving entity and to determine a turning possibility using sensor data recorded by the environmental sensor system and the speed of the motor vehicle determined by the speedometer. The controller is further adapted to cause communication of turning information of the interface to the driving entity of the motor vehicle as a function of the determination of the turning possibility.

### BACKGROUND

A control system for turning a motor vehicle and a corresponding method are disclosed here. This system and the associated method can be used in particular to support the driver in motor vehicles steered by a driver, but can also be used in a motor vehicle with complete or partially autonomous control. Details of this are defined in the claims; the description and the drawings also contain relevant information on the system and the mode of operation as well as on variants of the system and the method.

### TECHNICAL FIELD

The support of a driver of a motor vehicle by control systems or driver assistance systems contributes to the driving comfort and the operational safety of (motor) vehicles. Control systems or driver assistance systems can support the driver in efficient driving of the motor vehicle in traffic. Operator convenience of a motor vehicle can be increased, the driving of a motor vehicle made easier and the safety of all road users positively influenced by this.

Known driver assistance systems for the driver of a motor vehicle that increase driving comfort are speed alert systems or parking assistants, for example.

One driving situation that might be particularly difficult to assess for the driver of a motor vehicle can be the turning of a motor vehicle in a traffic situation. The spread of new technologies in automotive construction, for example, the use of steerable rear wheels/rear axles, makes it possible to reduce further the space required for turning. Thus even complete turning of a motor vehicle in one manoeuvre, for example on main roads, is facilitated. However, it can be difficult for the driver of a motor vehicle to assess, especially in a traffic situation with oncoming traffic, whether turning, which can in particular also necessitate deceleration of the motor vehicle, is possible safely or may cause a potentially hazardous traffic situation.

### Underlying Problem

In spite of existing driver assistance systems, a requirement thus exists for an improved control system and an improved control method for turning a motor vehicle.

### Proposed Solution

This problem is solved by a control system according to claim 1 and a control method according to claim 9. The dependent Claims define advantageous configurations.

A control system for turning a motor vehicle is based on an environmental sensor system of the motor vehicle. The environmental sensor system is adapted to identify at least one area in a direction of travel in front of the motor vehicle, in particular a road width. A speedometer is provided and adapted to determine a speed of the motor vehicle. An interface is provided and adapted to communicate turning information to a driving entity of the motor vehicle. A controller is provided and adapted to identify a turning desire of the driving entity and to determine a turning possibility using sensor data acquired by the environmental sensor system and using the speed of the motor vehicle determined by the speedometer. Furthermore, the controller is adapted to bring about communication of turning information of the interface to the driving entity of the motor vehicle as a function of the determination of the turning possibility.

At least a part of the environmental sensor system can be arranged in the front of the motor vehicle, so that an area in a direction of travel in front of the motor vehicle can be identified. In particular, a road width or space utilizable for turning of the motor vehicle can be identified. To this end the environmental sensor system can comprise visually recording sensors, in particular camera sensors, radar and/or lidar sensors, ultrasonic sensors and/or infrared sensors. A combination of said sensors is possible.

Furthermore, the environmental sensor system can also comprise sensors that are positioned on another outer side of the motor vehicle, for example at the rear of the motor vehicle. Identification of an area behind, laterally behind and/or laterally next to the motor vehicle can be facilitated by this. In particular, other road users behind, laterally behind and/or laterally next to the motor vehicle can be identified in this way. The individual sensors of the environmental sensor system can also be arranged pivotably on the motor vehicle. The sensors can be pivoted, in particular as a function of a steering movement of the motor vehicle, in such a way that the recording area of the sensors is pivoted following a directional change of the vehicle.

The environmental sensor system is further arranged and formed to identify, apart from a space necessary for turning of the motor vehicle, for example a road width, moving and immobile objects and their distance from the own vehicle. Immobile objects can be, in particular, obstacles such as road boundaries, lane dividers or objects on a road, for example. In one embodiment, traffic signs can also be identified by the environmental sensor system. Moving objects can be other road users in particular, which follow the motor vehicle in the direction of travel, drive ahead of the motor vehicle in the direction of travel or approach the vehicle counter to the own direction of travel. In one variant, road users moving transversely to the direction of travel of the motor vehicle can also be identified, for example pedestrians crossing the road or vehicles crossing the road at an intersection.

The environmental sensor system can further be arranged and formed to identify traffic routes joining the road and/or widenings in the road, for example parking bays. In particular, the environmental sensor system can identify an extent of the traffic route joining the road and/or of the widenings of the road along a direction of travel of the motor vehicle. In one embodiment, the environmental sensor system can be further arranged and formed to identify at least a minimum extent of the traffic route joining the road and/or of the widenings of the road orthogonally to a direction of travel of the motor vehicle.

The speedometer can be a normal vehicle tachometer, which determines the current speed of the motor vehicle. The speedometer can thus be connected to the controller so that the controller can use a speed determined by the speedometer to determine a turning possibility.

The controller is adapted to determine a turning possibility using the sensor data that is recorded by the environmental sensor system and the speed of the motor vehicle determined by the speedometer. Here the controller can determine by means of the sensor data a relative speed and a distance of moving objects identified, in particular oncoming vehicles and/or vehicles following the motor vehicle. The controller can further determine by means of the identified road width or the space available for turning a maximal turning speed and a turning duration to be expected. The controller can likewise determine whether the speed of the motor vehicle has to be reduced to carry out a turning manoeuvre of the motor vehicle.

By means of the relative speed and the distance of other, in particular oncoming, vehicles and the own speed of the motor vehicle, the controller determines an available time window/period in which the turning of the motor vehicle can be carried out without a potentially hazardous traffic situation arising. The controller can further determine, by means of the own motor vehicle speed and the available road width, the maximal vehicle speed at which the turning manoeuvre can be carried out and how long the execution of a turning manoeuvre is likely to last. In this case an expected duration of a deceleration required for turning the motor vehicle and/or an acceleration after concluding the actual turning manoeuvre in particular can also be taken into account. In one embodiment, the controller can also determine, by means of the sensor data, a relative speed and a distance to another vehicle following the motor vehicle in the direction of travel, and can judge whether a potentially hazardous traffic situation could arise due to an approach of the following motor vehicle as a result of a deceleration of the motor vehicle required for turning. The controller can further determine whether immobile objects, for example lane dividers or objects on the road, stand in the way of turning of the motor vehicle.

By means of the determined available time window/period, the determined probable turning duration, the determined turning space available, the determined immobile objects, the determination of a distance and a relative speed of vehicles approaching the motor vehicle and/or the determination of a distance and a relative speed of vehicles following the motor vehicle, the controller further determines whether a turning possibility exists.

In one variant, the controller can determine a turning possibility for turning in one manoeuvre. In other words, the controller can determine a turning possibility in which a single steering movement is to be executed, so that a direction of travel of the motor vehicle is changed by 180°.

Alternatively or in addition, the controller can be adapted to determine a turning possibility in 3 manoeuvres. The controller can determine a turning possibility in 3 manoeuvres in particular if there was identified by the environmental sensor system a road widening or the joining of a traffic route, which has in particular an identified minimal extent orthogonally to the direction of travel of the motor vehicle and is free of moving or immobile objects. The controller determines in this case the probable duration of a turning manoeuvre, in which the motor vehicle is first moved past the road widening or the joining of a traffic route in the original direction of travel, then backwards, thus substantially opposite to the original direction of travel, into the road widening or the joining of a traffic route and finally is moved out of the road widening or joining of a traffic route so that the vehicle moves at 180° opposite to the original direction of travel.

Depending on the determination of the turning possibility, the controller causes communication of appropriate turning information to the driving entity of the motor vehicle by the interface. The turning information can display an existing turning possibility or negate the existence of a turning possibility.

Furthermore, the controller can repeat or update the determination of the turning possibility at predetermined continuous intervals, for example at an interval of 3 seconds, and depending on the repeated determination can adapt the communication of appropriate turning information to the driving entity of the motor vehicle by the interface.

The driving entity of the motor vehicle can either be the driver of a motor vehicle, wherein the interface is a user interface, or the driving entity of the motor vehicle can be an autonomous motor vehicle controller, wherein the interface is an electronic data interface with the autonomous motor vehicle controller.

The interface, which is in particular a user interface or a data interface, can be adapted to emit, as a function of a turning possibility determined by the controller, turning information to the driver of the motor vehicle or to the autonomous vehicle controller so that the driver of the motor vehicle is informed about the determined turning possibility or so that the autonomous vehicle controller can execute turning of the motor vehicle on the basis of the determined turning possibility.

The control system can comprise an operator element for the driver of the motor vehicle in the interior of the motor vehicle, wherein the driver of the motor vehicle can generate a turning desire to the operator element. The operator element can be in particular a gear lever, a button or a touch-sensitive surface/touch display, which can be actuated by the driver to indicate his turning desire. The operator element can further be adapted to emit an operator signal to the controller, so that this registers the turning desire of the driver.

In a further development, the driving entity, in particular the driver of the motor vehicle, can specifically indicate, for example through the operator element, a turning desire to turn in one manoeuvre or a turning desire to turn in 3 manoeuvres.

If the driving entity of the motor vehicle is an autonomous motor vehicle controller, this can communicate a turning desire via the data interface to the controller, so that the controller registers the turning desire of the autonomous motor vehicle controller.

The controller can further be adapted to identify a time at which the turning desire of the driving entity is registered and/or to identify a time at which the communication of the turning possibility to the driving entity is brought about. To do this the control system can have a chronometer, which can be integrated in particular into the controller. Depending on the identification of the time and/or the speed of the motor vehicle, the controller can determine a termination period, wherein communication of the turning information by the interface to the driving entity can be terminated after the determined termination period has elapsed since the time determined.

One advantage in this case is that turning information is only communicated to the driving entity of the motor vehicle, for example, for as long as the proposed turning manoeuvre is to be executed safely and/or that turning information that negates a turning desire of the driving entity is only communicated over a predetermined period.

In one variant the termination period can be a predetermined timespan, in particular a timespan with a duration of 180 seconds.

In a further development, the environmental sensor system can further be arranged and formed to identify a traffic sign. In this case the control system can also comprise a database, in particular a traffic sign database, which is provided and adapted to store information for identifying predetermined traffic signs. The controller can further be adapted to identify a detected traffic sign using the information stored in the database. The interface can further be adapted to communicate information about an identified traffic sign to the driving entity of the motor vehicle.

An advantage here is that a traffic sign, for example, which indicates a turning prohibition, can be recognised by the controller. The information on a turning prohibition indicated by a traffic sign can be taken into account in the determination of the turning possibility and appropriate information can be communicated to the driving entity of the motor vehicle.

To this end the interface can comprise a visually recognisable display element in the interior of the motor vehicle, which is adapted in particular to reproduce a traffic sign identified by the controller in a visually recognisable manner, in particular schematically, for the driver of the motor vehicle.

The interface can further comprise a visually recognisable display in the interior of the motor vehicle, in particular a heads-up display, which is adapted to reproduce a turning possibility for the driver of the motor vehicle in a visually recognisable manner, in particular schematically. For example, a turning course determined by the controller for the motor vehicle can be displayed for the driver with a heads-up display so that this is superimposed in a schematically visible manner for the driver over a road view.

The interface can comprise an acoustic signal generator in the interior of the motor vehicle, which is adapted in particular to reproduce an acoustic signal as a function of a traffic sign identified by the controller. The interface can further comprise a haptic signal generator in the interior of the motor vehicle.

Furthermore, relevant information, for example a determined optimal and/or maximal speed for a turning manoeuvre, can be communicated to the driver. In particular, the information can be displayed for the driver in a visually recognisable manner. In the event of a maximal determined speed being exceeded during a turning manoeuvre, a haptic, acoustic and/or optical warning can be given to the driver.

In a further development, the control system can comprise a position sensor, in particular a satellite navigation system, for determining a current position of the motor vehicle. The controller can be further adapted to determine, after identification of a turning desire of the driving entity, a current position of the motor vehicle with the position sensor and to determine a path to a nearest turning possibility as a function of the current position of the motor vehicle. This can take place in particular with the aid of known navigation systems. The controller can further bring about communication of path information of the interface to the driving entity of the motor vehicle as a function of the determination of the path. This can take place alternatively or in addition to the determination of a turning possibility described above. In one exemplary embodiment, the determination of the path can take place in particular if a turning possibility is negated by the controller. The nearest turning possibility can be, for example, a road widening (for example a turning circle/turning area) or a suitable joining traffic route that is stored in the navigation system.

A control method for the turning of a motor vehicle is based on an environmental sensor system of the motor vehicle and comprises the steps:
identification of an area in a direction of travel in front of the motor vehicle by an environmental sensor system;
determination of a speed of the motor vehicle by a speedometer;
identification of a turning desire of a driving entity by a controller;
determination of a turning possibility by the controller using sensor data recorded by the environmental sensor system and the speed of the motor vehicle determined by the speedometer;
communication of turning information to a driving entity of the motor vehicle by an interface.

### BRIEF DESCRIPTION OF THE DRAWING

Further aims, features, advantages and application possibilities result from the following description of exemplary embodiments, which are not to be understood as restrictive, with regard to the associated drawings. Here all described and/or depicted features show by themselves or in any combination the subject matter disclosed here, even independently of their grouping in the claims or their retrospective references. The dimensions and proportions of the components shown in the figures are not to scale in this case; they may deviate from what is shown here in embodiments to be implemented.

FIG. 1 shows schematically and by way of example the identification of a traffic situation by an environmental sensor system of a motor vehicle.

FIG. 2 shows schematically and by way of example a control system for a motor vehicle.

FIGS. 3-5 show schematically and by way of example the turning of a motor vehicle in one manoeuvre.

FIGS. 6-9 show schematically and by way of example the turning of a motor vehicle in three manoeuvres.

### DETAILED DESCRIPTION OF THE DRAWINGS

Comparable and identical components and features, and components and features having the same effect, are provided with the same reference signs in the figures. For reasons of clarity, reference signs of individual features and components have also been omitted in the figures in some cases, wherein these features and components have already been provided with reference signs in other figures. The components and features, which are not described afresh in regard to the other figures, are similar in their formation and function to the corresponding components and features according to the other figures.

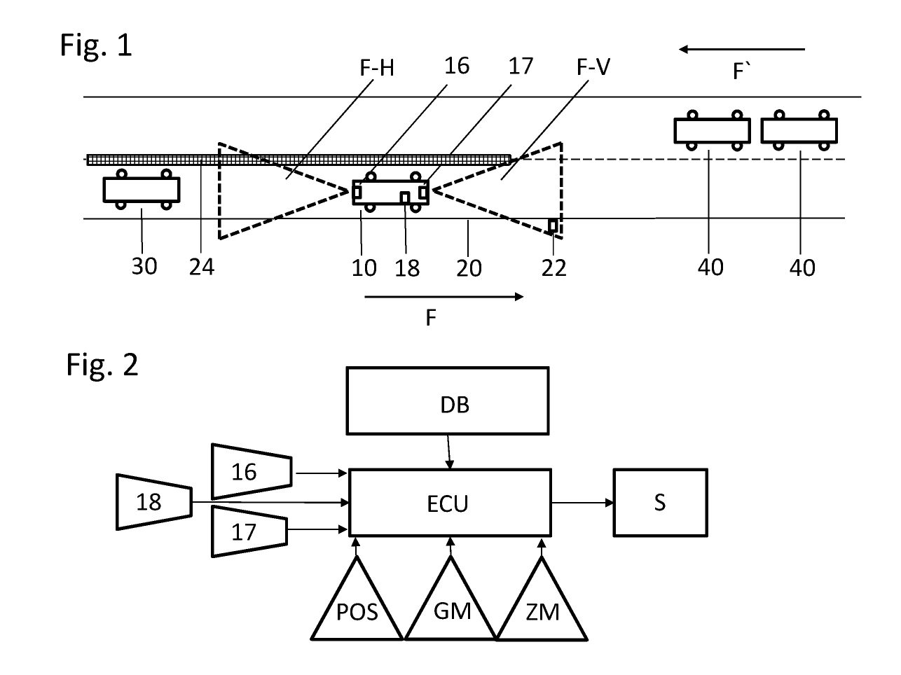

FIG. 1 shows as an example the identification of a traffic situation by an environmental sensor system of a motor vehicle 10. To this end the motor vehicle 10 has a rear sensor 16, a front sensor 17 and a lateral sensor 18. The rear sensor 16, a front sensor 17 and the lateral sensor 18 are visually recording camera sensors in the example shown.

The rear sensor 16 with the recording area F-H is positioned on the rear side of the motor vehicle 10. The front sensor 17 with the recording area F-V is positioned on the front side of the motor vehicle 10. The lateral sensor 18 is positioned on the right outer side of the motor vehicle 10 in the direction of travel F of the motor vehicle 10. The purely schematically indicated recording area F-V of the front sensor 17 is located in front of the motor vehicle 10 in the direction of travel F and the purely schematically indicated recording area F-H of the rear sensor 16 is located behind the motor vehicle 10. The recording areas F-V, F-H are not restricted by the schematically indicated extent.

In the example shown, the front sensor 17 of the motor vehicle 10 identifies a road width of the road 20, a traffic sign 22, the structural lane delimitation 24 and the oncoming vehicles 40 on an adjacent lane or the opposing lane. The vehicles 40 are moving here in the opposing direction of travel F′. The rear sensor 16 identifies the structural lane delimitation 24 and the vehicle 30 following the own motor vehicle 10. The sensors 16, 17, 18 shown are formed to identify both moving and immobile objects and to determine a distance of the moving and immobile objects from the own motor vehicle 10.

FIG. 2 shows schematically and as an example a control system for a motor vehicle 10. The control system shown has a controller ECU, which accesses sensor data obtained by the sensors 16, 17, 18. The control system further has a database DB, which stores in particular information for the identification of traffic signs, a position sensor POS, which with the aid of a satellite position determination method determines a position of the motor vehicle 10, a speedometer GM, which measures a current speed of the motor vehicle and a chronometer ZM. The controller ECU can access information which is stored in the database DB, the position determined by the position sensor POS, the speed determined by the speedometer GM and a time period measured by the chronometer ZM.

The controller is further adapted to identify a turning desire of a driving entity. This can take place, for example, by the registration of an actuation of an operator element (not shown) by the driver of the motor vehicle.

The controller can cause an interface S to communicate to the driving entity of the motor vehicle 10, for example the driver of the motor vehicle 10, turning information, for example in the form of a visually recognisable display. The interface S is controlled accordingly by the controller ECU to this end.

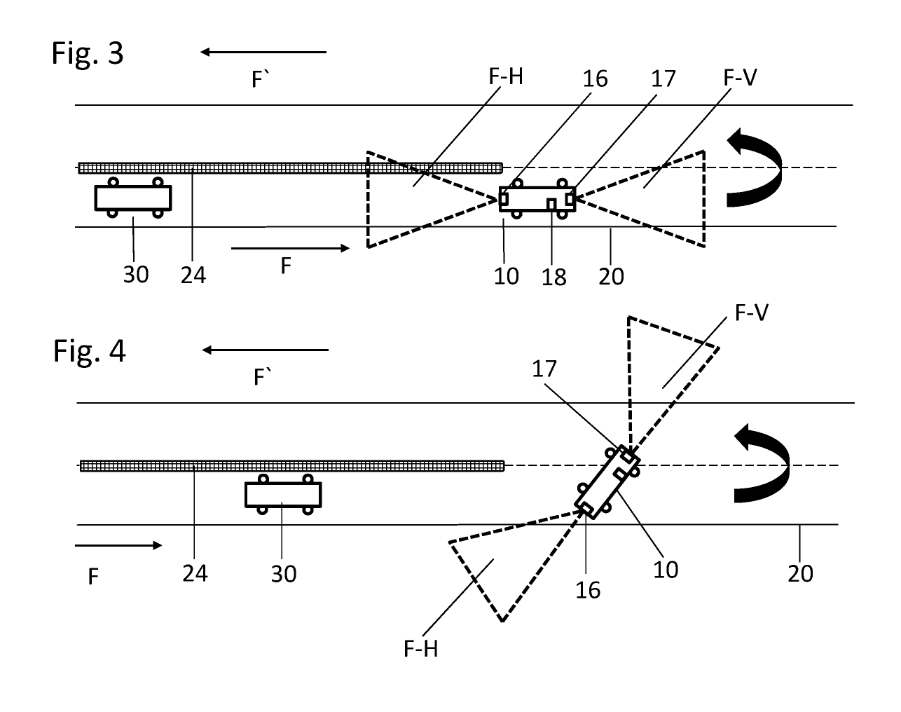

FIG. 3 shows the determination of a turning possibility by the controller ECU of the motor vehicle 10. In the example shown, the driving entity of the motor vehicle 10 has communicated a turning desire to the controller ECU. Furthermore, the controller ECU in the example shown is adapted to determine a turning possibility of the motor vehicle 10 in one manoeuvre.

Using the sensors 16, 17, 18, the controller ECU determines that no moving or immobile objects, which would stand in the way of turning of the motor vehicle 10, are located in front of the motor vehicle 10 in the direction of travel F. In particular, the front sensor 17 does not identify any oncoming vehicles or immobile objects such as the structural delimitation 24. Furthermore, the controller ECU determines using the sensors 16, 17, 18 that a vehicle 30 following the own motor vehicle 10 does not represent any hazard during a turning manoeuvre to be executed, on account of its distance from and its relative speed with regard to the own motor vehicle 10.

Using the sensors 16, 17, 18, the controller ECU further determines a width of the road 20, which offers the available space for turning the vehicle in the example shown and following from this an optimal turning radius for the motor vehicle 10. The optimal turning radius for turning in one manoeuvre is to be determined by the controller in this case so that the width of an available road or of an available turning area is utilised to the fullest possible extent. The width of a road or of an available turning area here describes its spatial extent orthogonally to the current direction of travel of the motor vehicle.

The smallest possible turning radius of the motor vehicle 10 is stored in the database DB. In other embodiments the smallest possible turning radius is filed directly in the controller ECU.

If the optimal turning radius determined is equal to or greater than the smallest possible turning radius stored, the controller ECU determines the current speed of the motor vehicle 10 using the speedometer GM and a maximal speed for the turning of the motor vehicle 10 as a function of the previously determined optimal turning radius. An approach of the vehicle 30, which is following the own vehicle 10 in the direction of travel F, on account of braking of the motor vehicle 10 to execute the turning manoeuvre is taken into account by the controller ECU to assess a possible hazard.

Since in the example shown neither moving nor immobile objects in the environment of the motor vehicle 10 obstruct or jeopardise turning of the latter and the optimal turning radius determined is greater than the stored smallest possible turning radius, the controller ECU causes turning information to be communicated to the driving entity of the motor vehicle 10 by the interface. The turning information contains the optimal turning radius determined and an associated maximal speed. If the driving entity of the motor vehicle is a driver, for example, the determined optimal turning radius and an associated maximal speed can be displayed to the latter by means of a heads-up display.

If the controller ECU determines on the other hand that safe turning of the motor vehicle 10 is not possible, appropriate turning information can be communicated by the interface S to the driving entity of the motor vehicle 10. If the driving entity of the motor vehicle is a driver, for example, a corresponding visually recognisable display in the interior of the motor vehicle 10 and an acoustically perceptible alarm tone can be initiated, for example. In addition, the controller ECU can determine a path to a suitable turning point, for example to a turning area provided for this, using the position sensor POS and a navigation system (not shown), and communicate suitable path information to the driving entity of the motor vehicle, for example by a visually recognisable display in the interior of the motor vehicle.

FIG. 4 shows the initiation of turning of the motor vehicle 10 by the driving entity of the motor vehicle 10. In this case the driving entity follows the turning information communicated by the interface S and moves at the maximal speed determined by the controller ECU on the optimal turning radius determined. In the example shown, the recording areas F-V, F-H of the sensors 16, 17 are pivoted as a function of the steering movement of the driving entity. The recording area F-V of the sensor 17 is pivoted in the direction of the steering movement of the driving entity and the recording area F-H of the sensor 16 is pivoted in the opposing direction. Recording by the environmental sensor system during turning is improved by this. For example, a vehicle 30 following the motor vehicle 10 can be recorded for longer during the turning process.

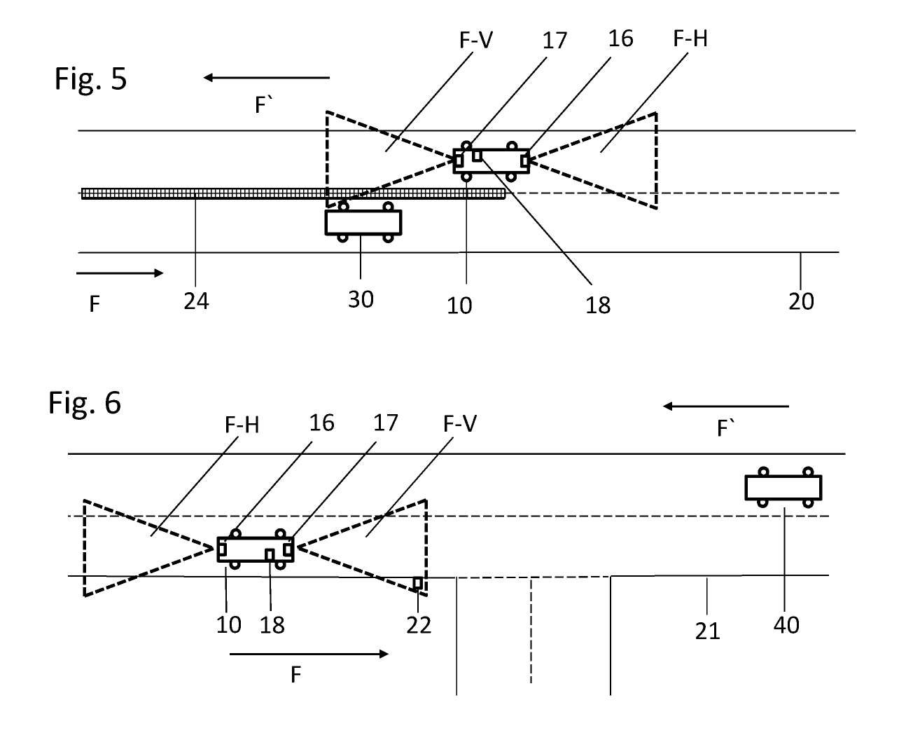

FIG. 5 shows the completed turning process. The motor vehicle now moves in the opposite direction of travel F. The recording areas F-V, F-H of the sensors 16, 17 are pivoted back to the original position again following the conclusion of the turning manoeuvre.

FIG. 6 shows an alternative determination of a turning possibility by the controller ECU of the motor vehicle 10. In the example shown, the driving entity of the motor vehicle 10 has communicated a turning desire to the controller ECU. Furthermore, the controller ECU in the example shown is adapted to determine a turning possibility of the motor vehicle 10 in three manoeuvres.

The controller ECU determines using the sensors 16, 17, 18 that there is located in the direction of travel F in front of the motor vehicle 10 a vehicle 40 moving in the opposing direction F′, which would stand in the way at least of turning of the motor vehicle 10 in one manoeuvre.

The controller ECU further determines a traffic sign 22 using the sensors 16, 17, 18. By comparing the traffic sign 22 visually identified in particular by the front sensor 17 with image information that is stored in the database DB, the controller ECU determines that the traffic sign 22 is not the display of a turning prohibition. The controller ECU thus refrains from causing the corresponding turning prohibition information to be communicated to the driving entity of the motor vehicle by the interface S.

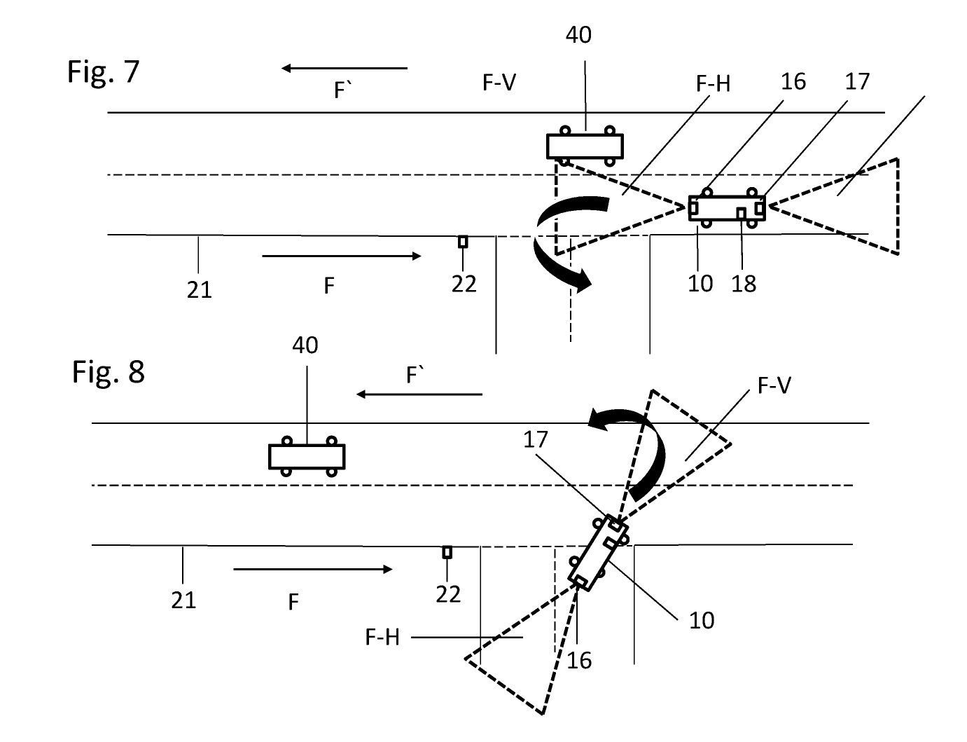

FIG. 7 shows the traffic situation from FIG. 6, after the motor vehicle 10 has passed a traffic route joining in the direction of travel F. The controller ECU now determines using the sensors 16, 17, 18 that no moving or immobile objects stand any longer in the way of the turning desire of the driving entity, as the oncoming vehicle 40 has now passed the own motor vehicle 10 and no further vehicles/moving objects and/or immobile objects were identified either in the direction of travel F or in the opposing direction of travel F′. The controller ECU has also determined using the lateral sensor 18 that the joining traffic route already passed is free of moving and/or immobile objects and has at least a predetermined width, so that it is suitable for executing a turning operation in three manoeuvres.

The controller ECU first causes the communication of stopping information to the driving entity of the motor vehicle 10. As soon as the motor vehicle is stopped by the driving entity, the controller further causes the communication of reversing information to the driving entity of the motor vehicle 10, wherein the controller ECU determines the path to be reversed by means of the data determined using the speedometer GM and the chronometer ZM since the joining traffic route was passed. Alternatively the position sensor POS can also be used for this.

As soon as the motor vehicle 10 reaches the opening of the traffic route, the controller ECU determines an optimal (backward) turning radius for the motor vehicle 10. The optimal (backward) turning radius for turning in three manoeuvres should be determined in this case by the controller ECU so that the motor vehicle 10 can move backwards in a smallest possible turning radius. In other words, the motor vehicle should always be located as close as possible to a road edge of the joining traffic route during a backward movement.

The smallest possible turning radius of the motor vehicle 10 is stored in the database DB. In other embodiments the smallest possible turning radius is filed directly in the controller ECU.

If the optimal (backward) turning radius determined is equal to or greater than the stored smallest possible turning radius, the controller ECU thus causes the interface S to communicate turning information to the driving entity of the motor vehicle 10, which turning information contains a predetermined reversing speed, for example 4 km/h, a predetermined reversing distance, for example 2.5 vehicle lengths, and the optimal (backward) turning radius determined.

Controller ECU is adapted to determine the traffic situation during the turning manoeuvre repeatedly using the sensors 16, 17, 18 and to abort the turning of the motor vehicle 10 if a possibly hazardous traffic situation is ascertained.

FIG. 8 shows the driving situation after the predetermined reversing distance has been covered by the motor vehicle 10. The controller ECU now determines using the sensors 16, 17, 18, in particular using the front sensor 17, an available width of the road 21. The width of the road 21 describes here its spatial extent orthogonally to the original direction of travel F.

The controller ECU also further determines, following from the determined width of the road 21, an optimal (forward) turning radius for the motor vehicle 10. The optimal (forward) turning radius should be determined in this case by the controller ECU so that the width of an available road or of an available turning area is utilised as fully as possible.

The controller ECU causes (forward) turning information to be communicated to the driving entity of the motor vehicle 10 by the interface S. The turning information contains the optimal (forward) turning radius determined and an associated maximal speed.

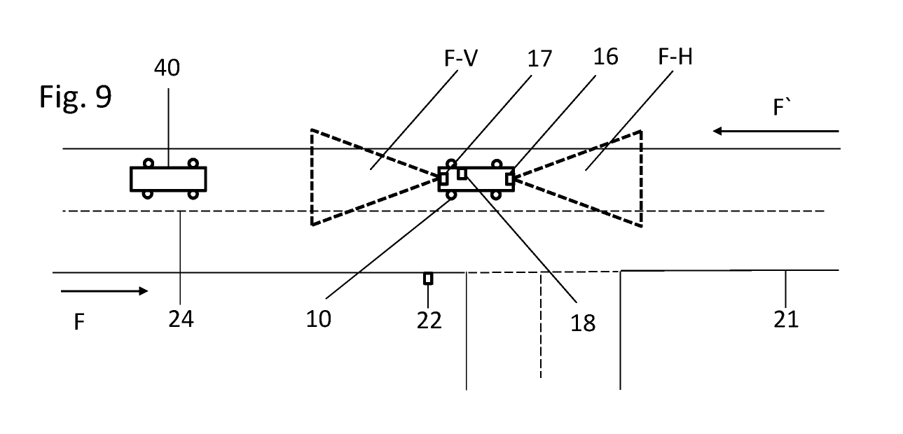

FIG. 9 shows the completed turning process in three manoeuvres. The motor vehicle now moves in the opposing direction of travel F′.

It is understood that the exemplary embodiments explained above are not definitive and do not restrict the subject matter disclosed here. In particular, it is evident to the person skilled in the art that he can combine the features described in any way with one another and/or can omit different features without departing from the subject matter disclosed here.

1. A control system for turning a motor vehicle, based on an environmental sensor system of the motor vehicle, wherein
the environmental sensor system is adapted to record at least one area in a direction of travel in front of the motor vehicle;
a speedometer is provided and adapted to determine a speed of the motor vehicle,
an interface is provided and adapted to communicate turning information to a driving entity of the motor vehicle,
a controller is provided and adapted to;
identify a turning desire of the driving entity,
determine a turning possibility using the sensor data recorded by the environmental sensor system and the speed of the motor vehicle determined by the speedometer,
bring about communication of turning information of the interface to the driving entity of the motor vehicle as a function of the determination of the turning possibility.

2. The control system according to claim 1, wherein the driving entity is a driver of the motor vehicle and the interface is a user interface, or the driving entity is an autonomous motor vehicle controller and the interface is an electronic data interface with the autonomous motor vehicle controller.

3. The control system according to claim 2, wherein the controller is further adapted to:
identify a time at which the turning desire of the driving entity is registered; and/or
identify a time at which the communication of the turning possibility to the driving entity of the motor vehicle is brought about, and/or
determine a termination period as a function of the identification of the time and/or the speed of the motor vehicle;
terminate the communication of the turning information by the interface after the determined termination period has elapsed since the determined time.

4. The control system according to claim 3, wherein the termination period is a predetermined timespan.

5. The control system according to claim 1, wherein the environmental sensor system comprises a visually recording sensor system.

6. The control system according to claim 1, wherein the environmental sensor system is further arranged and formed to identify a traffic sign, and/or
a database is provided and adapted to store information on the identification of predetermined traffic signs, and/or
the controller is further adapted to identify a recorded traffic sign using the information stored in the database,
the interface is further adapted to communicate information about an identified traffic sign to the driving entity of the motor vehicle.

7. The control system according to claim 1, wherein the interface comprises a visually recognisable display element in the interior of the motor vehicle, which is adapted to reproduce a traffic sign identified by the controller for the driver of the motor vehicle in a visually recognisable manner, and/or
the interface comprises a visually recognisable display in the interior of the motor vehicle, which is adapted to display a turning possibility for the driver of the motor vehicle in a visually recognisable manner, and/or
the interface comprises an acoustic signal generator in the interior of the motor vehicle, which is adapted to reproduce an acoustic signal as a function of a traffic sign identified by the controller, and/or
the interface comprises a haptic signal generator in the interior of the motor vehicle.

8. The control system according to claim 1, further comprising:
a position sensor for determining a current position of the motor vehicle, wherein
the interface is further adapted to communicate path information to the driving entity of the motor vehicle, and
the controller is further adapted:
to determine a current position of the motor vehicle using the position sensor,
to determine a path to a nearest turning possibility as a function of the current position of the motor vehicle,
to cause path information of the interface to be communicated to the driving entity of the motor vehicle as a function of the determination of the path.

9. A control method for turning a motor vehicle based on an environmental sensor system of the motor vehicle and comprising the steps:
recording of an area in a direction of travel in front of the motor vehicle by an environmental sensor system;
determination of a speed of the motor vehicle by a speedometer;
identification of a turning desire of a driving entity by a controller;
determination of a turning possibility by the controller using sensor data recorded by the environmental sensor system and the speed of the motor vehicle determined by the speedometer;
communication of turning information to a driving entity of the motor vehicle by an interface.
